(19) United States
(12) Patent Application Publication
(10) Pub. No.: US 2011/0195799 A1
(43) Pub. Date: Aug. 11, 2011

(54) GOLF CLUB SHAFT

(76) Inventor: Gerald F. Hogan, Caloundra West (AU)

(21) Appl. No.: 13/022,458

(22) Filed: Feb. 7, 2011

Related U.S. Application Data
(60) Provisional application No. 61/337,720, filed on Feb. 5, 2010.

(51) Int. Cl. A63B 53/10; A63B 53/00; B23P 11/00

(52) U.S. Cl. 473/319; 473/316; 473/318; 29/428

(57) ABSTRACT

A shaft for a golf club is comprised of upper, central and lower sections. Flex is isolated to the central section of the club by making the upper and lower sections relatively stiffer than the central section. Though more flexible, the central section resists twisting by fabricating the section using a higher percentage of diagonally oriented fibers laid in a crossing pattern. A thickened tip and larger diameter butt end enhance resistance to twisting of the shaft.

### TECHNICAL FIELD OF THE INVENTION

This invention pertains generally to golf clubs and golf club shafts.

### BACKGROUND OF THE INVENTION

A golf club is generally comprised of an elongated shaft and a club head. The upper end of the shaft is referred to as the butt end. The opposite, lower end of the shaft is called the tip. The diameter of the shaft generally tapers from the butt end to the tip. The club is gripped during the swing at the butt end of the shaft. A grip is placed on the butt end of the club for this purpose. Affixed to the tip is a club head, which is the portion of the club that strikes a golf ball. There are generally three types of golf club heads that are used for different types of golf shots—“woods” (including drivers, fairway woods and hybrids), “irons” (including wedges) and putters.

Golf shafts are typically designed to utilize the principles of kick and flex to provide a golfer with a desired ball flight. However, bending and flexing of a conventional shaft, which is necessary to for providing kick, makes it difficult for a player to consistently return the face of the club head to the direction the player intends the ball to travel. The more the shaft flexes, the more difficult it becomes to return it squarely and at maximum speed to the ball at impact. The more that a shaft twists, the more difficult it is to return to the ball correctly. Further, the more the shaft flexes and twists, the more susceptible it becomes to “drooping,” which compounds the difficulty for the golfer to impact the golf ball with the club head in an optimal manner. Drooping refers to the tendency of the club to bend downwardly, resulting in the toe dropping. It is caused by centrifugal force generated during the swing.

### SUMMARY

The invention relates, in one aspect, to a golf club shaft and its manufacture, and in another aspect, to a golf club made with the shaft. The shaft is capable of enhancing the playability of golf clubs, while providing the golfer with a club that will enhance control and ball flight distance of a golf ball.

### BRIEF DESCRIPTION OF THE DRAWINGS

FIG. 1 is a side view of a golf club shaft.

FIG. 2 is a side view of the golf club shaft of FIG. 1, with its butt end trimmed.

FIG. 3 is a side view of an assembled club with the shaft of FIG. 2.

### DETAILED DESCRIPTION OF EXEMPLARY EMBODIMENTS

In the following description, like numbers refer to like elements.

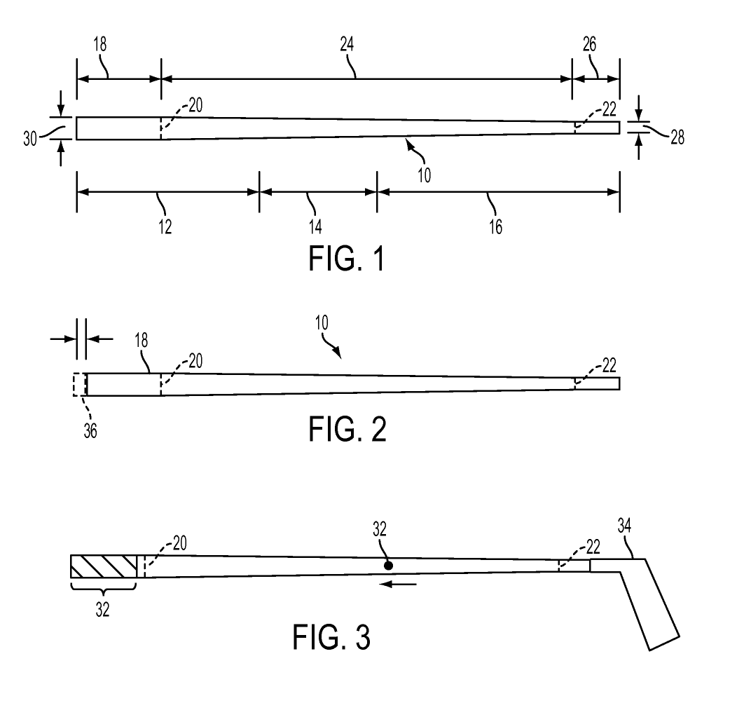

Referring to FIGS. 1-3, shaft 10 comprises a generally tubular object which is hollow and has a circular cross-section along most, if not all, of its central axis or longitudinal length. For purposes of describing the flex characteristics of the illustrated example of shafts, reference will be made to three sections of shaft 10: an upper section 12, a lower section 16; and a central section 14. The geometry of the club has three segments: a butt portion 18, a tapered portion 24 and a tip portion 26.

In this illustrated example, the butt portion 18, which is part of the upper section 12, is parallel, meaning that it does not taper and has a consistent cross-sectional outer diameter. The shaft transitions to the tapered portion 24 at a point indicated by dashed line 20. The tapering stops at a point indicated by dashed line 22, where it transitions to the tip portion 26 of the club. Tip portion 26 of the lower section 16 is also parallel, meaning it has a consistent cross-sectional diameter and does not taper. The tapered portion 24 has, in the illustrated example, has a uniform taper and comprises part of the lower section 16.

In one example of a shaft for a wood club, the shaft measures 44 inches, plus or minus 2 inches, in total length and weighs between 80 to 115 grams. In an example of a shaft for an iron club, the length is 41 inches, plus or minus 2 inches, and weighs between 80 to 115 grams. The length of the upper section 12 is 20 inches, plus or minus 3 inches. The central section 14 of the shaft is 10 inches, plus or minus 2 inches in total length. The length of the lower section 16, from bottom of the central section to the lower end of the tip portion 26 is 17 inches, plus or minus 2 inches.

The butt portion 18 of the upper section 12 extends from the end of the upper end of the shaft to a point indicated by dashed line 20. This point is, in the example, 12 inches, plus or minus 2 inches, above a top end of the central section 14. The total length of the butt portion 18 is approximately 8 inches for woods and 9 inches for irons.

The outer diameter 28 of the shaft tip made for a wood is sized to fit into a hosel of a wood head with an inner diameter in the range of 0.335 to 0.375 of an inch. If made for an iron, the outer diameter 28 for the shaft is sized to fit into a hosel having 0.370 inch inner diameter. Outer diameter 30 at the butt end is 0.600 of an inch.

The shaft is, for example, fabricated in a manner that results in a single, unitary structure. In the exemplary embodiment, the shaft is comprised of high modulus graphite fibers. However, other materials may be substituted to provide enhanced stability. During the manufacture, the fibers are cut and layered onto a metal rod, or mandrel, with the layers being positioned so as to provide the desired flexure of the particular shaft. The fibers are impregnated with resin. After the shaft has been constructed on the mandrel, it is heated to form the fibers into a composite mass.

The patterning of fibers and the number of layers of fiber at points along the mandrel controls how the shaft flexes. Generally, fibers that are laid longitudinal to the axis of the shaft have their greatest resistance to bending, but offer the least resistance to twisting. Conversely, a fiber that is laid at a diagonal to the axis provides the shaft with a greater resistance to twisting but offers reduced resistance to bending. Generally, the greater the angle of the fibers to the shaft, the greater the resistance to twisting and the lower the resistance to bending there is in the shaft at that point along its axis.

In an exemplary club, lower section 16 and upper section 12 are made comparatively very stiff, and central section 14 is made relatively less stiff. The upper and lower sections are each longer than the center section. The shaft can thus be described as having two levers joined by a relatively flexible joint. Because of this, the flex pattern of the shaft will be referred to herein as a two lever flail design.

Both the upper 12 and lower 16 sections are made to resist bending, preferably with as close to zero bending as possible during a normal golf swing. This is achieved in one example by laying 70%, plus or minus 10%, of the fibers in a longitudinal direction, and 30%, plus or minus 10%, diagonally with respect to the longitudinal axis of the shaft. The lower section, particularly the tip portion, is further stiffened by thickening the wall of the shaft in that section or portion with additional layers of fiber. The greater diameter of the upper section, particularly where the butt portion does not taper, as compared to the average diameter of conventional shafts, helps to stiffen the upper section 12.

The central section 14 is of comparatively much greater flexibility than the upper and lower sections. In the central section 14 of the exemplary shaft, 75%, plus or minus 15%, of the fiber content of the shaft at each point along this section is laid diagonally in a crossing pattern, with an equal number of fibers going each direction around the mandrel. The angle of the diagonally laid fibers with respect to the axis of the shaft is preferably between 35 and 55 degrees in one direction, and −35 to −55 degrees in the other direction. The crossing pattern allows the shafts to have a proportional amount of flex and twist in all directions. The remaining fibers, which should be 25%, plus or minus 15%, of the total fiber content of the shaft, are laid longitudinally, parallel to the axis of the shaft.

Fibers laid diagonally lower the resistance to bending proportionally and allow a controllable point of bending with increased resistance to twisting. With the crossing pattern, the fibers function both equally and in opposing directions, resulting in stability within the central section 14. Diagonally oriented fibers laid in opposite directions around the shaft also generate a strong spring force when twisted.

With this construction, very little twisting exists within the full shaft length during a conventional swing once a golfer's downswing has commenced and the club head has traveled a short distance. The length of the shaft over which twisting can occur is limited to the central section, and the strong spring forces generated by twisting counteract torque on the shaft and tend to return the shaft to a neutral position. The relatively large diameter of the shaft butt portion and thickened wall of the tip portion provide resistance to twisting and a reduced torque in the shaft. The more that the upper and lower sections are stiffened, the more the flex of the club is centered within the single zone and, therefore, the more controllable that flex becomes.

The cross patterning of the fibers in the central section 14 has another benefit. When the shaft bends, the circular wall of the shaft distorts and becomes oval in cross-section. The ability of the shaft wall to return to circular is determined by its inherent structure. The central section will, once bent, return to circular cross-section, and the shaft to its static configuration, very rapidly because of the high proportion of cross patterned fibers in this region.

The butt section is proportionally larger and heavier than the central section 14 and lower section 16 of the shaft than as compared to conventional shafts. This places the center of gravity 32 (FIG. 3) of the shaft closer to the butt section than in conventional shafts, which makes a club with the shaft easier to swing.

The thicker, butt end 18 of the upper section 12 of the shaft also enables golfers to have a uniform section to place a grip over. This longer parallel butt section—it is preferably long enough to accommodate the length of a standard golf club grip—enhances the shaft's overall stiffness and can increase a golfer's performance by enlarging the bottom portion of the player's grip. The longer parallel segment avoids a need to add additional tape under the bottom hand portion of the grip as a means to alleviate hooking a golf shot.

In addition to the fiber content and patterning, the stiffness of the lower section is achieved in the exemplary shaft by limiting the parallel portion 26 of the tip 16 to three inches, plus or minus 1 inch, rather than a longer tip typically found in conventional shafts. This permits the shaft to transition sooner to the tapered portion of the shaft, thus allowing the outer diameter of thee shaft to be made larger nearer the head of the club. The increased diameter enhances stability by increasing lateral and torsional rigidity. Further, the wall thickness in the tip portion may also be increased relative to conventional shafts for the purpose of increasing the stiffness of the tip portion. Making the parallel tip portion shorter, with greater wall thickness, permits the outer diameter of the tip to be changed during fabrication to fit hosels having different inner diameters, while still offering more resistance to bending and twisting as compared to the tip sections of shafts with conventional flex patterns.

The tip section according to this example provides greater stability of the club head immediately prior to and through the impact zone of the golf swing. The forces and inertia of a golfer's downswing create flexing and twisting in conventional shafts. However, the flexing and twisting is substantially reduced, and could be eliminated, within the first few feet of downswing travel using a shaft constructed according to the example described above. A shaft made in accordance with this design permits the club to arrive at impact with the shaft in a fully recovered, straight-line configuration, with little bending and twisting, and with very little droop.

Furthermore, the exemplary golf shaft substantially removes the element of “kick”, which is typically found in conventional shafts. The exemplary shaft tends to inhibit kick during a normal golf swing, so that the tip section and, therefore, the club head, do not pass the butt section of the club, and thus, the golfer's hands, during a normal swing of the club. The purported principle of kick is such that applied energy within the shaft flex and recovery in the downswing creates additional acceleration of a golf club head. However, it is very difficult for the golfer to time the release of the club head at precisely the point of impact. Further, if a golf shaft could successfully store energy by flexing backwards then any such energy must be applied against a resistance that is both equal and opposite. Therefore, if the head end of a golf club is to be accelerated then the butt end must be decelerated, causing a golfer to make an unnatural golf motion In essence, a shaft utilizing a two-lever flail design as described above provides a more effective transmission of energy into the golf ball as compared to a shaft without the design. The greater the transmission of energy at the point of collision with the golf ball, the further the ball will travel in flight.

Further supporting the reduction or elimination of shaft kick is the stability of the shaft tip, which is attached inside the hosel of the club head. Once acceleration of the head mass exceeds that of the shaft body, a shaft that offers kick will commence to drag on the inside extremity of the club head. The face length will act as a radial accelerator, applying a torque to the shaft and resulting in the shaft twisting, causing the toe of the golf club to pass the heel. This rotation of the head relative to the axis of the shaft leads to shots that deviate from the golfer's intended target.

The exemplary shaft described above further provides a more stable support for the club head throughout the impact phase. The layup of the fibers, the wall thickness, length, weight and rigidity of the tip section fully support the head and result in greater resistance to deceleration caused by impact with the golf ball. A typical club head will decelerate at approximately 20% upon collision with a golf ball. One factor in determining a golf ball's total distance is the speed of the ball upon separation from the club head, and not the overall speed of the golf club. A shaft made in accordance with the example described above can have a deceleration of as little as 8%, providing a greater energy transmission into the golf ball. For this reason, a golfer can swing a club fitted with such a shaft easier, at lower club head speeds, and yet impart the same amount, or possibly more, energy to the golf ball during the swing, thus hitting the ball as far as, or possibly further, than a conventional golf club, be it iron or wood, swung with greater effort.

The human mechanical system is a highly complex, multi-lever assembly and the golfer is such an assembly to which an additional lever, a golf club, has been added. If the club is balanced to be in compliance to the human system to which it is attached, then golf club will react in harmony to the motions and intentions of the player. It is the center of gravity that the brain of the golfer reacts to and responds to, not the head weight, feel or the overall weight of the golf club. If a golf club is not well balanced and assembled, the golfer will tend to react to the influences of the golf club. A club with a shaft made according to the example given above, is in enhances the unity and harmony of the assembly of a golfer and his golf club. Such a club has a positive effect on all players in the instinctive, reactive manner in which they adapt to swing the golf club.

During the manufacture, shaft 10 is not trimmed from the tip section 26 for use in wood clubs of different lengths, including drivers, fairway woods or hybrid clubs. Rather, the constant diameter butt portion 18 is trimmed to the designed length. This characteristic will enables immediate installation the shaft into a club head 34, and trimming a portion 36 off the butt end of the shaft to arrive at the overall desired length of the shaft.

Thus, according to the foregoing example of a golf club shaft, a shaft is comprised of stiff upper and lower sections joined in the middle by a relatively less stiff central section. The shaft is made in a manner that isolates the flex of the shaft to a central section of the club, allowing enhanced control of the amount of flex and reducing twist and droop of a golf club while in motion. A tip section having uniform outer diameter is made, as compared to typical golf shafts, shorter in length in order to stiffen it. A butt section having uniform outer diameter is formed during fabrication of the shaft so that it is long enough to permit trimming of the shaft to a desired length, depending on the type of club, during assembly of the club, and to accommodate a standard grip

The foregoing description is of exemplary and preferred embodiments employing at least in part certain teachings of the invention. The invention, as defined by the appended claims, is not limited to the described embodiments. Alterations and modifications to the disclosed embodiments may be made without departing from the invention. The meaning of the terms used in this specification are, unless expressly stated otherwise, intended to have ordinary and customary meaning and are not intended to be limited to the details of the illustrated structures or the disclosed embodiments.

What is claimed is:

1. A shaft for a golf club, the shaft being formed of a unitary, elongated body terminating at one end in a tip and the other end in a butt;
the tip having predetermined length, with a constant outer diameter along its length, and shaped and sized for insertion into a hosel of a club head; and
the butt having a predetermined length, with a constant outer diameter along its length, and shaped and sized for receiving a golf club grip;
wherein the shaft between the butt and the tip has an outer diameter that tapers along its length from the butt to the tip.

2. A shaft according to claim 1, wherein an upper section of the shaft, including the butt, and a lower section of the shaft, including the tip, are relatively stiffer than a section of the shaft between the upper and lower sections.

3. A shaft according to claim 1, wherein the shaft is comprised of fibers bonded by resin.

4. A shaft according to claim 1, wherein an upper section of the shaft, including the butt, and a lower section of the shaft, including the tip, are relatively stiffer than a central section of the shaft between the upper and lower sections.

5. A shaft according to claim 4, wherein the shaft is comprised of fibers bonded by resin that has been cured to form the unitary body, and wherein between 60 and 80 percent of the fibers in the upper section of the shaft and the lower section of the shaft are oriented in the direction of the shaft's longitudinal axis, and between 20 and 40 percent of the fibers are oriented diagonally with respect to the longitudinal axis.

6. A shaft according to claim 4, wherein the shaft is comprised of fibers bonded by resin that has been cured to form the unitary body, and wherein between 60 and 90 percent of the fibers in the section of the shaft between the upper and lower sections is laid diagonally in a crossing pattern, and between 10 and 40 percent of the fibers are oriented in the direction of the shaft's longitudinal axis.

7. A shaft according to claim 4, wherein the upper section of the shaft has a length of between 17 and 23 inches, the central section of the shaft has a length of between 8 and 12 inches, and lower section is between 15 and 19 inches.

8. A shaft according to claim 1, wherein the tip's outer diameter is sized to fit a hosel having an inner diameter of between 0.335 to 0.375 of an inch.

9. A shaft according to claim 1, wherein the tip has a length of between 2 and 4 inches.

10. A shaft according to claim 1, wherein the butt is approximately 8 inches in length.

11. A shaft according to claim 1, wherein the butt is approximately 9 inches in length.

12. A shaft for a golf club, the shaft being comprised of fibers bonded by resin that has been cured to form the unitary, elongated body terminating at one end in a tip and the other end in a butt;
the tip having predetermined length, with a constant outer diameter along its length, and shaped and sized for insertion into a hosel of a club head;
the butt having a predetermined length, with a constant outer diameter along its length, and shaped and sized for receiving a golf club grip;
wherein,
an upper section of the shaft, including the butt, and a lower section of the shaft, including the tip, are relatively stiffer than a central section of the shaft extending between the upper and lower sections;
between 60 and 80 percent of the fibers in the upper section of the shaft and the lower section of the shaft are oriented in the direction of the shaft's longitudinal axis, and between 20 and 40 percent of the fibers are oriented diagonally with respect to the longitudinal axis; and
between 10 and 40 percent of the fibers in the central section of the shaft are oriented in the direction of the shaft's longitudinal axis, and between 60 and 90 percent of the fibers are oriented diagonally with respect to the longitudinal axis.

13. A shaft according to claim 12, wherein the upper section of the shaft has a length of between 17 and 23 inches, the central section of the shaft has a length of between 8 and 12 inches, and lower section has a length between 15 and 19 inches.

14. A shaft according to claim 12, wherein the tip's outer diameter is sized to fit a hosel golf club head having an inner diameter of between 0.335 to 0.375 of an inch.

15. A shaft according to claim 12, wherein the tip has a length of between 2 and 4 inches.

16. A shaft according to claim 12, wherein the butt is approximately 8 inches in length.

17. A shaft according to claim 12, wherein the butt is approximately 9 inches in length.

18. A method of assembling a golf club comprising:
receiving a golf club shaft, the shaft being formed of a unitary, elongated body terminating at one end in a tip and the other end in a butt; the tip having predetermined length, with a constant outer diameter along its length, and shaped and sized for insertion into a hosel of a club head; and the butt having a predetermined length, with a constant outer diameter along its length, and shaped and sized for receiving a golf club grip;
inserting the tip of the shaft into a hosel of a club head without shortening the tip;
trimming the length of the butt to arrive at a desired, overall length for the golf club; and
fitting the butt with a grip.

19. The method of claim 18, further comprising manufacturing the shaft.
